(19) United States
(12) Patent Application Publication
(10) Pub. No.: US 2001/0052848 A1
(43) Pub. Date: Dec. 20, 2001

(54) Audio transmission security device

(76) Inventor: Vernon Lewis, Missouri City, TX (US)

Correspondence Address: ROBERT W STROZIER, PLLC, 2925 BRIARPARK, SUITE 930, HOUSTON, TX, 77042, US

(21) Appl. No.: 09/850,194

(22) Filed: May 7, 2001

Related U.S. Application Data
(63) Continuation of application No. 09/430,005, filed on Oct. 29, 1999, now abandoned.

(51) Int. Cl. G08B 21/00

(52) U.S. Cl. 340/540; 340/539; 340/307; 340/384.7; 340/384.5

(57) ABSTRACT

A personal security system including a base unit which communicates emergency voice information to a surrounding area through and amplified speaker/siren system. The security system includes a held-held remote “panic button” unit to allow activation of an amplified call for help. The unit uses an RF transmitter and receiver to trigger a digitally recorded voice/siren when the panic button is pushed. Once triggered, the pre-recorded voice and or siren alarm will sound continuously until positively reset. The base unit of the present invention is suitable for installation inside a vehicle.

### BACKGROUND OF THE INVENTION

1. Field of the Invention

In one aspect, the present invention relates to security devices, and to methods of using such devices. In another aspect, the present invention relates to audio security devices and to methods of using such devices. In even another aspect, the present invention relates to audio security devices utilizing a pre-recorded message, in the user's own voice, to discourage or prevent a dangerous situation and to methods of using such devices. In still another aspect, the present invention relates to audio security devices having a remote “panic button” unit, which when activated, delivers a user's pre-recorded message, designed to discourage or prevent a dangerous situation, and to methods of using such devices.

2. Description of the Related Art

The have been several attempts in the prior art to provide for safety devices.

U.S. Pat. No. 5,764,134 issued Jun. 9, 1998, to Carr et al. discloses an audio police identification and distraction device that is sufficiently rugged to be thrown inside a structure to be searched and deliver electronically a digitally store, high volume voice message that clearly identifies the police or law enforcement agency and distracts persons inside the structure during a hard entry. The audio device includes a voice message memory chip, a rechargeable battery operated power supply, an amplifier, a speaker assembly and a user activated switch and delay circuit.

U.S. Pat. No. 5,734,316 issued Mar. 31, 1998, to Swanson, Jr. discloses a canine auditory transmission apparatus having a remote unit which can be activated by a policeman.

U.S. Pat. No. 5,307,047 issued Apr. 26, 1994, to Morioka discloses a ring fitted with a device that sounds an alarm during times of emergencies. The ring includes a transmission circuit and alarm device that emits a sound enclosed in the setting of the ring. The switches are at the top of the setting forming a connection between the transmission circuit and the battery when pressed.

U.S. Pat. No. 4,810,996 issued Mar. 7, 1989 to Glen et al. discloses a dental patient communication device to be used in instances when verbal communication is impossible or impracticable such as during dental examination or treatment. The device includes a hollow housing, at least one and preferably three alarm buttons, and at least one audible alarm circuit capable of emitting a variety of distinct sounds and activated by the alarm buttons so that the communication of the sensation of various levels of discomfort is accomplished between patient and dentist. The devices is either to be hand held or mounting on an examination apparatus.

Therefore, in spite of these advances in the prior art there is a need for improved security devices, and to methods of using same.

There is another need in the art for improved audio security devices and to methods of using same.

There is even another need in the art for improved audio security devices, utilizing a pre-recorded message, in the user's own voice, to discourage or prevent a dangerous situation and to methods of using such devices.

These and other needs in the art will become apparent to those of skill in the art upon review of this specification and drawings.

### SUMMARY OF THE INVENTION

It is an object of the present invention to provide for security devices and methods of using security devices which do not suffer from the disadvantages of the prior art.

It is another object of the present invention to provide for improved security devices, and to methods of using same.

It is even another object of the present invention to provide for improved audio security devices, utilizing a pre-recorded message, in the user's own voice, to discourage or prevent a dangerous situation and to methods of using such devices.

These and other objects of the present invention will become apparent to those of skill in the art upon review of this specification and drawings.

According to one embodiment of the present invention, there is provided a security apparatus including a remote transmitter and a base unit having a receiver and a speech recording and playback device, where when activated by the remote transmitter, the speech recording/playback device broadcasts a distress broadcast including at least a pre-recorded message in the user's own voice to a surrounding area at a sufficient volume to alert people in the area of a potential attack and decrease the likelihood that the attack will continue.

The present invention also provides a method, for broadcasting a distress message, including broadcasting a distress message in a user's own voice from an apparatus of the present invention to a surrounding area at a sufficient volume to alert people in the area of a potential attack and decrease the likelihood that the attack will continue.

The present invention also provides a method, for broadcasting a distress message, including activating the recording/playback device via the remote transmitter and receiver and broadcasting a pre-recorded distress message in a user's own voice to a surrounding area at a sufficient volume to alert people in the area of a potential attack and decrease the likelihood that the attack will continue.

The present invention also provides a method, for programming an apparatus of the present invention, including recording a distress message in a user's own voice on the recording/playback device of the apparatus of the present invention.

### BRIEF DESCRIPTION OF THE DRAWINGS

The invention can be better understood with reference to the following detailed description together with the appended illustrative drawings in which like elements are numbered the same:

FIG. 1 is an assembly view of the halves of RF transmitter 10 of the present invention;

FIG. 2 is connection diagram of RF receiver 20 and voice module and siren driver board 30; and

FIG. 3 is a partial cross-sectional view of receiver 20 of the present invention mounted in a vehicle 100.

### DETAILED DESCRIPTION OF THE INVENTION

The inventor has found that people and the public in general have become increasingly immune to the sound of an electronic alarm system. Such alarm system are found in many cars and are more of a nuisance than a deterrent, because the devices tend to go into an alarm state far to frequently. Thus, like the boy that cried wolf for fun, no one comes when the alarm condition evidences a real theft. The inventor designed the present invention to address this immunity to the alarm by incorporating into the alarm broadcast at least pre-recorded message in a user's own voice.

The security device of the present invention broadly is a personal security system, having a remotely triggered voice alarm, which when activated, emits or broadcasts a continuous or intermittent distress signal or broadcast including at least a pre-recorded distress message in a user's own voice.

The security device includes a base unit, which broadcasts, emits or communicates the emergency voice information to a surrounding area through an amplified speaker/siren system, and a held-held remote “panic button” unit to allow the user to remotely initiate the amplified call for help. Once triggered, the user's pre-recorded voice message and a siren or other electronic emergency messages will sound continuously or intermittently until positively reset, with continuous broadcasting being preferred. The base unit and speaker/siren of the present invention is suitable for installation, for example, inside a vehicle, home, building, mailbox or garage.

The present invention also broadly relates to a method of increasing a user's security including activating a playback unit with a remote trigger device and broadcasting a distress broadcast including at least a pre-recorded distress message in the user's own voice.

Suitable recording/playback devices can include any device capable ofrecording voice and electronic data in any format including analog or digital. Preferably, the device records the information in digital format. Such devices include, without limitation, CD recording/playback devices, DVD recording/playback devices and chip based recording/playback device. Of course, the base unit ofthe present invention can be designed to operate on a CD or DVD or chip that has the user's voice message pre-recorded thereon. The units can also include more than one pre-recorded voice message. The playback unit should be capable of producing a distress message that can be readily heard in a surrounding area of at least a 50 foot radius center at the speaker of the playback unit, preferably at least a 100 foot radius and particularly at least a 500 foot radius. These distances are relative to unobstructed areas. The actual area may vary with obstructions.

Suitable speakers include any audio reproduction device that can convert an electronic signal into sound including solid-state speakers, diaphragm speakers, or the like. Horns and sirens can also be included to generate the optionally electronic sounds evidencing an emergency situation. The base unit can include more than one speaker.

Suitable remote transmitters and associated base unit receiver can be any hand-held transmitting device and associated receiving device capable of transmitting a signal over a given distance that can be easily received at sufficient amplitude to trigger the playback device in the base unit of the present invention. The preferred transmitter/receiver are RF devices as are well-known in the art. The remote transmitter unit can include one or a number of different panic buttons so that the user can potentially activate different voice distress messages depending on the particular situation. Thus, if the user is being attacked, the message could be “HELP I AM BEING ATTACKED. PLEASE CALL 911” or if the user's house, store or shop is being broken into or robbed, the message could be “HELP SOMEONE IS BREAKING INTO MY HOUSE. PLEASE CALL 911.” The playback unit would have to determine which button was depressed by recognizing its button id and playback the distress information, message and electronic sounds, corresponding to that button as is well-known in the art.

The broadcast of the present invention includes at least a pre-recorded voice message of the user. The broadcast can also include electronic emergency signals such as electronically generated siren sounds like those used by emergency vehicles or other load sounds designed to alert person in a surrounding area that the user of the device of the present invention is in need of emergency assistance. The apparatus could also be used by elderly people or people with medical conditions to alert person in a surrounding area that the user of the device of the present invention is in need of emergency assistance.

Referring now to the figures, the security device of the present invention will be shown and described in detail.

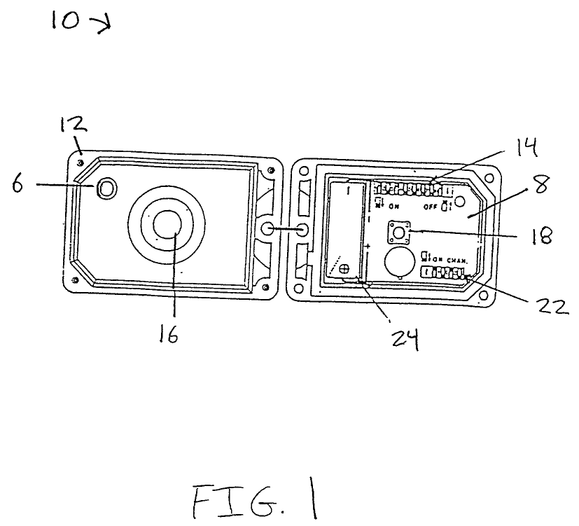

Referring to FIG. 1 there is shown an assembly view of the halves of the RF transmitter, shown generally as 10, of the present invention. Transmitter 10, generally includes housing 12. Housing 12, shown open, contains transmitter board 8, code selector switch 14, push button 16, push button switch 18, channel selector 22, battery 24 and LED indicator 26.

RF transmitter 10 may be any commercially available push button or “panic button” type unit designed to be hand held or conveniently worn by the user. For example, transmitter 10 may be placed on a key chain, attached to a lanyard or necklace and worn about the neck, or clipped or otherwise attached to the user's clothing, belt, purse, briefcase, car visor and the like.

Housing 12 may be made from any suitable material, but is preferably a plastic housing secured together by set screws, not shown. Code selector switch 14 allows entry of a particular security code to correspond to that entered in the systems corresponding receiver. The ability to select the code prevents activation of the system by a third party. Channel selector 22 allows selection of a particular signal transmission channel. Battery 24 supplies power for the transmission of an RF signal, generated by transmitter board 8, when push button switch 16 is depressed.

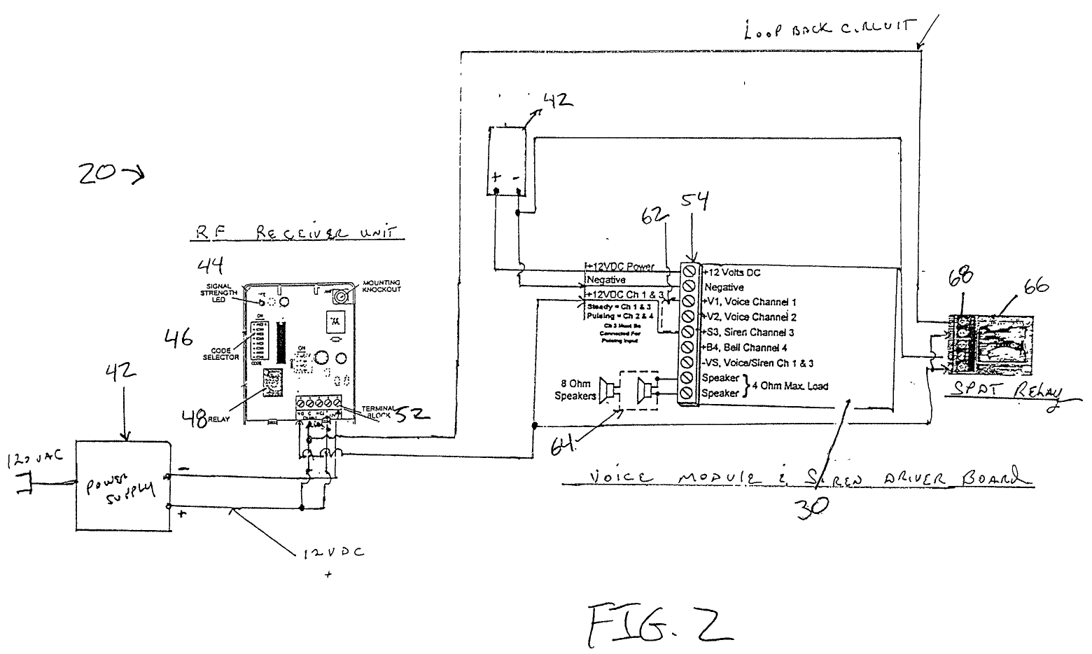

Referring to FIG. 2 there is shown a connection diagram of one embodiment of the electrical circuit of the RF receiver, shown generally as 20, and of voice module and siren board, shown generally as 30, of the present invention. RF receiver 20 and voice module and siren board 30 are powered by power supply 42.

RF receiver unit 20 generally includes signal strength LED 44, code selector switch 46, relay 48, and terminal block 52. Terminal block 52 of RF receiver 20 connects to terminal block 68 of relay 66 of voice module and siren board 30. Voice module siren board 30 also includes power terminal block 54, voice channel jumper 62 and speaker 64. Receiver 20 and voice module and siren board 30 form a “base unit” which, when activated by transmitter 10, is designed to communicate emergency information, selected by the user and digitally recorded in the user's own voice, to a surrounding area.

RF receiver 20 may be any commercially available RF receiver unit, which is designed to receive the signal broadcast by transmitter 10.

Voice module board 30 may be any commercially available speech recording and playback device. Voice module board 30 preferably includes an electrically erasable, programmable, read-only memory for storing digitized voice data. Voice data is selected and pre-recorded into module board 30 by the user and may include any suitable message.

Power supply 42 may be any suitable device to supply power to receiver 20 and voice module and siren board 30. Non-limiting examples of a suitable power supply 42 include any AC power source, DC battery supply or combinations thereof.

Code selector switch 46 allows entry of a particular security code corresponding to that entered in code selector 14 of transmitter 10.

In operation, once switch 16 on RF transmitter is depressed and the signal is received by receiver 20, receiver relay 48 activates voice module board relay 66 to broadcast the user's pre-recorded message through output speakers 64. The user may record and select the playing of one or more voice messages and or the sounding of an alarm, siren or bell by positioning jumper 62 on terminal block 54 as is known in the art to select the desired output. The user may select to broadcast a voice message, an alarm, siren or bell, or a combination thereof.

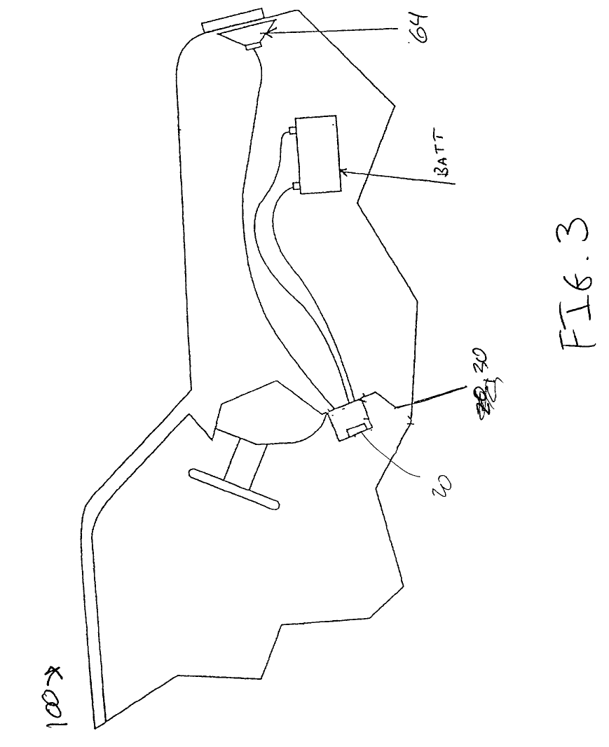

Referring to FIG. 3, there is shown a partial cross-sectional view of receiver 20 and voice module board 30 of the present invention installed in vehicle 100.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains.

I claim:

1. A security device comprising:
(a) a transmitter; and
(b) a base unit comprising:
(i) a receiver for receiving a signal from the transmitter; and
(ii) a speech recording and playback device activated by the transmitter;
wherein when activated, the speech recording playback device emits a distress signal previously recorded by a user in the user's own voice.

2. The security device of claim 1, wherein the transmitter is an RF transmitter and the receiver is an RF receiver.

3. The security device of claim 1, wherein the speech recording and playback device is programmable and stores analog or digital voice data.

4. The security device of claim 1, wherein the distress signal further comprises an alarm, siren or bell.

5. The security device of claim 1, wherein the base unit is mounted in a vehicle, a garage, a house, an apartment or a mailbox.

6. A security device comprising:
(a) an RF transmitter; and
(b) a base unit comprising:
(i) an RF receiver for receiving a signal from the transmitter; and
(ii) a digital speech recording and playback device activated by the transmitter;
wherein when activated, the speech recording playback device emits a distress signal previously recorded by a user in the user's own voice.

7. The security device of claim 6, wherein the distress signal further comprises an alarm, siren or bell.

8. The security device of claim 6, wherein the base unit is mounted in a vehicle, a garage, a house, an apartment or a mailbox.

9. A method of generating a distress broadcast comprising:
broadcasting a broadcast message comprising a pre-recorded distress message in a user's own voice signal to a surrounding area from a security apparatus comprising a transmitter and a base unit including a receiver for receiving a signal from the transmitter; and a speech recording and playback device activated by the transmitter.

10. The method of claim 9, wherein the transmitter is an RF transmitter and the receiver is an RF receiver.

11. The method of claim 9, wherein the speech recording and playback device is programmable and stores analog or digital voice data.

12. The method of claim 9, wherein the distress signal further comprises an alarm, siren or bell.

13. The method of claim 9, wherein the base unit is mounted in a vehicle, a garage, a house, an apartment or a mailbox.

14. A method of utilizing a security device comprising:
(a) programming a pre-recorded voice distress message into a speech recording playback device;
(b) activating the speech recording playback device by a remote transmitter and a receiver; and
(c) broadcasting the pre-recorded distress signal to a surrounding area.

15. The method of claim 14, wherein the transmitter is an RF transmitter and the receiver is an RF receiver.

16. The method of claim 14, wherein the speech recording and playback device is programmable and stores analog or digital voice data.

17. The method of claim 14, wherein the distress signal further comprises an alarm, siren or bell.

18. The method of claim 14, wherein the base unit is mounted in a vehicle, a garage, a house, an apartment or a mailbox.
